(19) United States
(12) Patent Application Publication
(10) Pub. No.: US 2015/0312487 A1
(43) Pub. Date: Oct. 29, 2015

(54) IMAGE PROCESSOR AND METHOD FOR CONTROLLING THE SAME

(71) Applicant: CANON KABUSHIKI KAISHA, Tokyo (JP)

(72) Inventor: Yuichi Nomoto, Kawasaki-shi (JP)

(21) Appl. No.: 14/690,270

(22) Filed: Apr. 17, 2015

(30) Foreign Application Priority Data
Apr. 23, 2014 (JP) 2014-089537

(51) Int. Cl. H04N 5/262; H04N 5/232

(52) U.S. Cl. CPC H04N 5/2621; H04N 5/23222; H04N 5/23293

(57) ABSTRACT

An image processor according to the present invention includes: an image capturing unit; an image processing unit configured to perform image processing on an image captured by the image capturing unit; a detection unit configured to detect a shooting scene for the image captured by the image capturing unit; a determination unit configured to determine the priorities of a plurality of different image processing methods to be used by the image processing unit based on the result of the detection by the detection unit; and a control unit configured to control the image processing unit so as to generate a plurality of images on which different methods of the plurality of image processing methods image processing have been performed in accordance with the priorities, where in the control unit simplifies image processing by using lower-priority image processing methods of the plurality of different image processing methods.

### BACKGROUND OF THE INVENTION

1. Field of the Invention

The present invention relates to an image processor which enables bracket shooting providing a plurality of images from one image, which are subjected to different shooting conditions or image effects, and to a method for controlling the image processor.

2. Description of the Related Art

There has been an image capturing apparatus capable of providing a plurality of images from one image obtained by one shooting, by conducting different types of image processing on the image.

Also, there has been such image processing that detects an object or scene for a captured image and changes the gradation characteristics of the image accordingly.

Japanese Patent Application Laid-Open No. 2009-071768 A, for example, discloses an image signal processor that uses a technique of: performing uniform gradation conversion processing on a target pixel with reference to a gradation conversion characteristic curve selected based on information on an object; and carrying out local gradation conversion processing on the processed target pixel based on information on regions near the pixel. With the technique, the image signal processor can obtain an image with the optimum gradation characteristics for a scene or a main object.

The apparatus, however, suffers from a fact that selecting an appropriate image effect for every shooting is disadvantageously time-consuming.

### SUMMARY OF THE INVENTION

In view of the above, the present invention provides an image processor and an image processing method which can detect a shooting scene and generate a plurality of images to which different image effects appropriate for the detected shooting scene are respectively applied.

The present invention includes, an image processor according to the present invention includes: an image capturing unit; an image processing unit configured to perform image processing on an image captured by the image capturing unit; a detection unit configured to detect a shooting scene for the image captured by the image capturing unit; a determination unit configured to determine the priorities of a plurality of different image processing methods to be used by the image processing unit based on the result of the detection by the detection unit; and a control unit configured to control the image processing unit so as to generate a plurality of images on which different methods of the plurality of image processing methods image processing have been performed in accordance with the priorities, where in the control unit simplifies image processing by using lower-priority image processing methods of the plurality of different image processing methods.

Further features of the present invention will become apparent from the following description of exemplary embodiments (with reference to the attached drawings).

### BRIEF DESCRIPTION OF THE DRAWINGS

FIG. 1 is a block diagram illustrating an example of the configuration of a digital camera 100 according to an embodiment.

FIG. 2 is a processing flow illustrating the entire processing according to the embodiment.

FIG. 3 is a diagram illustrating an example of display by a display section 28 according to the embodiment.

FIGS. 4A and 4B are each a diagram illustrating the adaptations between scene elements and image effects according to the embodiment.

### DESCRIPTION OF THE EMBODIMENTS

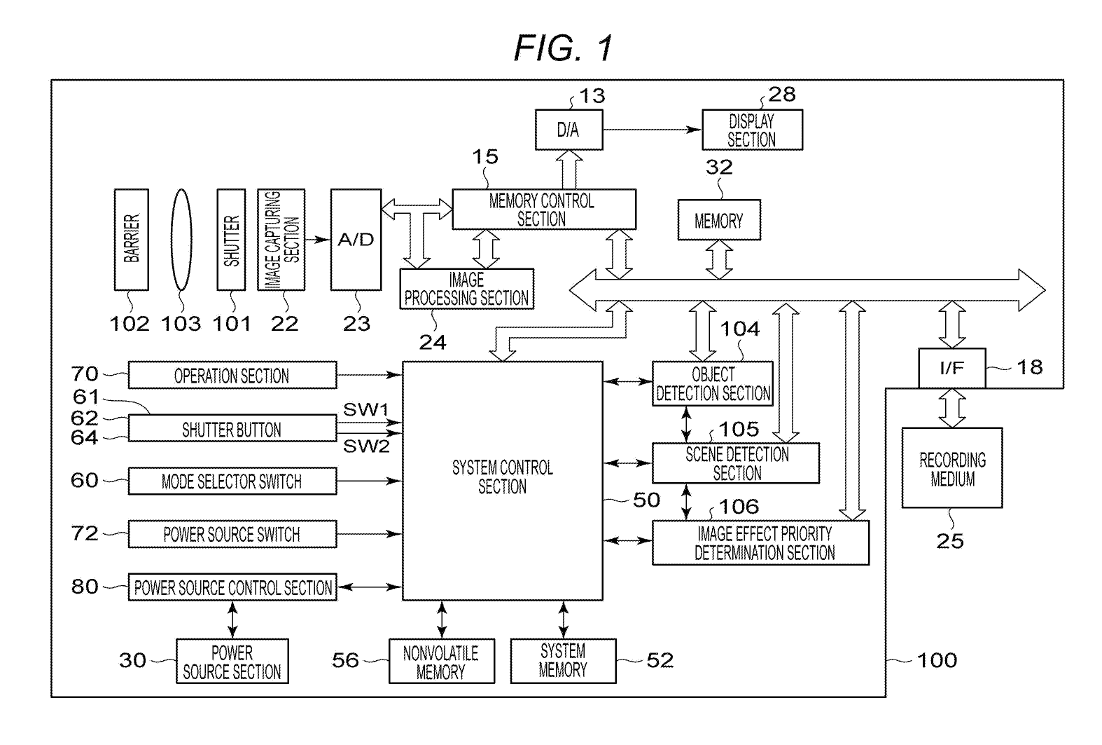

A preferred embodiment of the present invention will be hereinafter described in detail with reference to accompanying drawings. FIG. 1 is a block diagram illustrating an example of the configuration of a digital camera 100 according to the embodiment.

### First Embodiment

In a first embodiment, processes are performed of detecting a shooting scene, determining the priorities of image effects based on the detected scene, applying the higher-priority ones of the image effects to an input image, and simplifying other lower-priority ones of the image effects determined to be applied to the image.

The digital camera 100 of FIG. 1 includes a taking lens 103 with a focus lens, a shutter 101 with a diaphragm function, an image capturing section 22 having a CCD, a CMOS, etc. converting an optical image into an electric signal, an A/D converter 23 converting an analog signal output from the image capturing section 22 into a digital signal, and a barrier 102 covering the image capturing section including the taking lens 103 to prevent contamination or breakage of the image capturing systems, such as the taking lens 103, the shutter 101, and the image capturing section 22.

An image processing section 24 in FIG. 1 performs not only resizing processing including predetermined pixel interpolation and reduction but also color conversion processing on data (image signal) from the A/D converter 23 or a memory control section 15, and further conducts predetermined operational processing using captured image data. Based on the result of the operational processing, a system control section 50 controls light exposure and distance measuring. In that way, AF (auto focus) processing, AE (auto exposure) processing, and EF (pre-flash) processing of TTL (through the lens) system are carried out. The image processing section 24 additionally performs predetermined operational processing using the captured image data, as well as AWB (auto white balance) processing of the TTL system based on the result of the operational processing. Note that the TTL system is not the only option in the embodiment and a dedicated sensor may be separately used for acquiring evaluation values.

Further, the image processing section 24 carries out luminance detection processing on the captured image, divides a frame image on the picture into a plurality of regions, and determines an average luminance of each region. Subsequently, the image processing section 24 obtains, using the average luminances, luminance information including the luminance difference between the center and the periphery of the image and the center luminance of the image, for example. The detected luminance information is held in a memory 32.

The image processing section 24 also performs color detection processing on the captured image to detect color information including an average chroma and the area of the high-chroma region. The detected color information is held in the memory 32.

Moreover, the image processing section 24 conducts, on data output from the A/D converter 23, various different types of image processing, such as demosaicing, white balance, shading correction, distortion correction, matrix operation, gamma correction, and compression/encoding, which are usually applied to the data in ordinary shootings as well.

The image processing section 24 executes image processing for applying an image effect to the image data on which part of the processing listed above has been conducted. Examples of the applicable image processing for image effect in the embodiment include diorama image processing, toy-camera image processing, fisheye-lens image processing, oil-painting image processing, and water-painting image processing. The diorama image processing provides an image with an effect of making the main object in the image look distinguished and the entire image look like a diorama by making the image gradually blur in a direction from a predetermined region to the edges of the image. In the diorama image processing, an original image is subjected to filtering or reduction/enlargement processing so that the image is blurred, the blurred image and the original image are synthesized with each other for each region, and a final image is generated. The more the number of taps of the filer is, the larger the degree of blurring is. In the meanwhile, if an image is reduced and is thereafter enlarged to its original size, the degree of blurring is increased. Using those phenomena, blurred images with several different blurring levels are generated in order that a final image can be obtained in which the blurring changes more smoothly in the synthesis step.

The toy-camera image processing usually generates a final image by reducing the amount of light in regions around an image (lowering the brightness of pixels for a higher image height by increasing the gain) and then imparting a noise, for example.

The fisheye-lens image processing significantly distorts the edges of an image.

The oil-painting image processing lowers the gradations of a luminance signal and a color signal of an image, for example.

The water-painting image processing generates a final image with high-frequency components of a luminance signal being left and a color signal being blurred, for example.

The beautiful skin processing generates a final image by detecting the skin color of a region found by face detection and converting the colors of the face region and the regions around the face region in the similar color as the skin color into colors which make the skin look more beautiful or by increasing the luminances of the regions or by performing smoothing processing on the regions.

Data output from the A/D converter 23 is directly written into the memory 32 via both the image processing section 24 and the memory control section 15 or via the memory control section 15 alone. In the memory 32, there is stored image data which has been obtained by the image capturing section 22 and converted into digital data by the A/D converter 23, and image data to be displayed by the display section 28. The memory 32 has a sufficient memory capacity for storing static images taken a predetermined number of times and dynamic images and sounds recorded for predetermined periods of time.

Further, the memory 32 acts as a memory (video memory) for displaying images. Reference number 13 denotes a D/A converter, which converts data for image display stored in the memory 32 into an analog signal and supplies the analog signal to the display section 28. The image data for display written in the memory 32 is displayed by the display section 28 via the D/A converter 13. The display section 28 displays data for the analog signal from the D/A converter 13 on a display unit, such as an LCD. In the embodiment, there is provided a through-image display (live-view display) function, which sequentially displays in the display section 28 image data captured by the image capturing section 22 and sequentially output from the A/D converter 23.

Reference number 56 denotes a nonvolatile memory which is electrically erasable and recordable, and an example of the memory 56 is a FROM. The nonvolatile memory 56 stores the constants, programs, etc. of the actions and operations of the system control section 50. The program herein means a program for executing a flow chart described hereinafter in the embodiment.

Reference number 50 denotes a system control section for controlling the entire digital camera 100. Specifically, the system control section 50 realizes each processing (described later) in the embodiment by executing the programs stored in the nonvolatile memory 56. Reference number 52 denotes a system memory, of which example is a RAM. The system memory 52 stores the constants and variables of the actions and operations of the system control section 50 and the programs read from the nonvolatile memory 56, for example, in the decompressed form. Also, the system control section 50 performs display control by controlling the memory 32, the D/A converter 13, and the display section 28, for example.

Reference numbers 60, 61, 62, 64, and 70 respectively denote a mode selector switch, a shutter button, a first shutter switch, a second shutter switch, and an operation section, which are all operational units for inputting various different operational instructions to the system control section 50.

The shutter button 61 includes the first and second shutter switches 62 and 64 and is an operation section configured to issue a shooting instruction.

The mode selector switch 60 switches the operation mode of the system control section 50 among a static image recording mode, a dynamic image recording mode, and a reproduction mode, for example.

The first shutter switch 62 is turned on by so-called “half push” of the shutter button 61 (meaning “in the middle of operation on the shutter button 61”) of the digital camera 100, the half push herein being equivalent to an instruction to prepare for a shooting, and generates a first shutter switch signal SW1. The first shutter switch signal SW1 causes AF (auto focus) processing, AE (auto exposure) processing, AWB (auto white balance) processing, EF (pre-flash) processing, etc. to start.

The second shutter switch 64 is turned on by so-called “full push” of the shutter button 61 (meaning completion of the operation on the shutter button 61), the full push herein being equivalent to an instruction to shoot, and generates a second shutter switch signal SW2. In the system control section 50, the second shutter switch signal SW2 causes a series of shooting processing starting with reading a signal from the image capturing section 22 and ending with writing image data to a recording medium 25 to start.

The operation members of the operation section 70 are provided with appropriate functions on a case-by-case basis selected by a user from various different function icons displayed in the display section 28, and act as function buttons. Examples of the function buttons include a termination button, a return button, an image forward button, a jump button, a refining button, and an attribution change button. For example, when a menu button is pressed, the display section 28 shows a menu screen, on which various different settings are possible. A user can make settings on the menu screen displayed on the display section 28 by intuition, using a four-way button and a SET button.

Reference number 80 denotes a power source control section including a battery detection circuit, a DC-DC converter, and a switch circuit for changing a block to apply a current. The power source control section 80 detects the presence or absence of a fixed battery, the type of the battery, and a remaining battery level, controls the DC-DC converter based on the result of the detection and an instruction from the system control section 50, and supplies a required voltage to the recording medium 25 and other sections for a required period of time.

Reference number 30 denotes a power source section including a primary battery, such as an alkaline battery and a lithium battery, a secondary battery, such as a NiCd battery, a NiMH battery, and a Li battery, and an AC adapter. Reference number 18 denotes an interface with the recording medium 25, such as a memory card and a hard disk. The recording medium 25 includes a semiconductor memory and a magnetic disk. Reference number 72 denotes a power source switch for switching the power source between an ON state and an OFF state.

Reference number 104 denotes an object detection section detecting the entire object region from an image. The object region herein means the region of an image which forms an object, and is expressed by the center and the horizontal and vertical sizes of the face of a person or a pet and is displayed as the facial frame. The object detection section 104 may be configured to detect the object region by template matching based on the outline of an object.

Reference number 105 denotes a scene detection section detecting a scene where an image has been taken. A shooting scene is detected based on the size and positional coordinates of the object region of an image detected by the object detection section 104, the composition of the image, and the luminance and color tone of the image, for example.

The scene detection operation by the scene detection section 105 will be described. The scene detection section 105 discriminates the background of a shooting scene, using the luminance information and color information on an image held in the memory 32, and discriminates the object in the shooting scene, using the object information obtained by the object detection section 104.

For example, the scene detection section 105 analyzes luminance information and color information on an image held in the memory 32, determines whether the area of the blue region of the image is not smaller than a threshold value, and concludes that the background of the shooting scene for the image is a blue sky if the blue region is not smaller than the threshold value.

The scene detection section 105 also analyzes the luminance information and color information on an image held in the memory 32, determines whether the area of the green region of the image is not smaller than a threshold value, and concludes that the background of the shooting scene for the image is a field of grass if the green region is not smaller than the threshold value.

The scene detection section 105 analyzes the luminance information and color information on an image held in the memory 32 as well, determines whether the luminances of the image satisfy a predetermined histogram distribution and the conditions of the distribution, and concludes that the background of the shooting scene for the image is a night scene if the distribution and conditions are satisfied. The luminances of an image when the shooting scene for the image is a night scene are mostly low and the luminance distribution value is high, meaning that a high-luminance part singly generates.

Further, the scene detection section 105 similarly analyzes the luminance information and color information on an image held in the memory 32, determines whether the average chroma of the image and the area of the high-chroma region of the image are not smaller than a threshold value, and concludes that the shooting scene for the image is a bright scene if the average chroma and the area of the high-chroma region are not smaller than the threshold value.

The following is the description of discrimination of an object from a shooting scene.

The scene detection section 105 analyzes an object region detected by the object detection section 104, and concludes that the object in the shooting scene is a person if a face of a person is detected.

The scene detection section 105 analyzes an object region detected by the object detection section 104, and concludes that the object in the shooting scene is a pet if a face of a pet is detected.

The scene detection section 105 analyzes the size information and positional information on the object region of an image, determines whether the size of the object is larger than a threshold value and whether the positional coordinates of the object are not larger than a predetermined distance from the center of the image, and concludes that the shooting scene for the image has the Japanese flag composition (the composition in which the object is at the center of an image) if the size is larger than the threshold value and the positional coordinates are not larger than the predetermined distance.

The scene detection section 105 thus makes a final judgment about a scene by detecting the background and the object of the scene and combining them. For example, if the scene detection section 105 determines that the background of a shooting scene is a field of grass and the object is a pet, it concludes that the shooting scene has a field of grass and a pet. On the other hand, if the scene detection section 105 determines that the background of a shooting scene is a blue sky and the object is neither a person nor a pet, it concludes that the shooting scene has only the blue sky.

Reference number 106 denotes an image effect priority determination section, which determines the types and priorities of image effects to be applied on an image from a scene detected by the scene detection section 105.

Image effects are image processing performed on an input image to alter original impressions of the image, and include the toy-camera image effect, fisheye-lens image effect, diorama image effect, water-painting image effect, oil-painting image effect, and beautiful-skin processing. Since each shooting scene has its own appropriate image effects, the image effect priority determination section 106 calculates the priorities of the image effects for determining the appropriate ones for each shooting scene, and selects the image effects with priorities not lower than a threshold value in descending order of priority as the image effects to be actually applied.

The digital camera 100 is capable of shooting that uses central one point AF or face AF. The central one point AF is AF performed on one point at the center of a taken image, and the face AF is AF performed on the face in a taken image detected by a face detection function.

It is to be noted that the configuration of the image capturing apparatus shown in FIG. 1 is only an example and other configurations may be employed for the image capturing apparatus as long as they allow the following operations to be carried out.

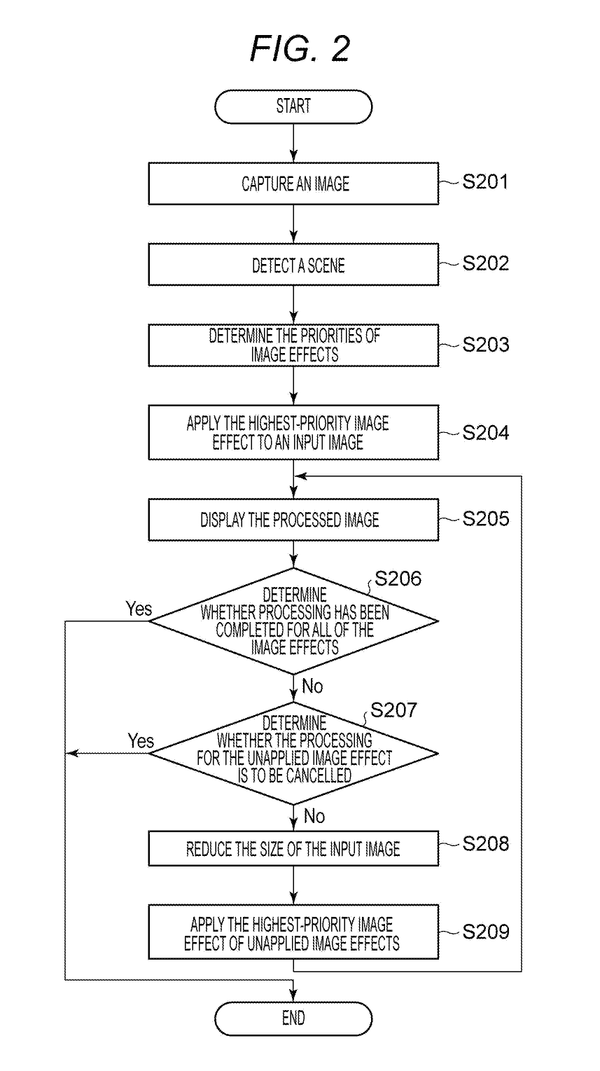

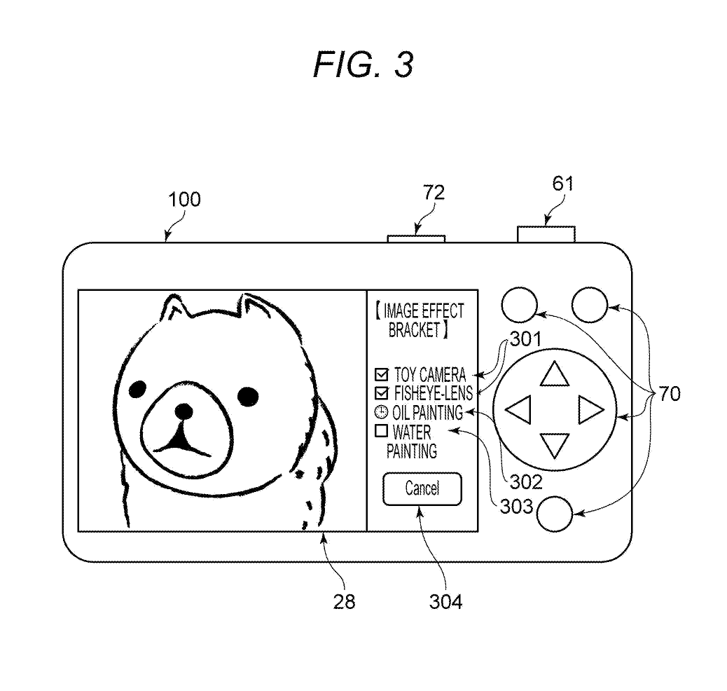

An image is taken by the image capturing apparatus shown in FIG. 1 and a scene is detected by the scene detection section 105 from an input image taken under the control by the system control section 50. After the types and priorities of image effects (image processing methods) to be exerted on the input image are determined by the image effect priority determination section 106, the input image is subjected to the image processing for the image effects by the image processing section 24 in descending order of priority and is displayed in the display section 28. The processing flow of the image effect bracket shooting (image capturing) will be described with reference to FIGS. 2 and 3. The processing in each step is carried out by the corresponding section with the system control section 50 or with the memory 32 according to an instruction from the system control section 50.

In FIG. 3, reference number 301 denotes the name of an image effect having been processed displayed in the display section 28.

Reference number 302 denotes the name of an image effect in the middle of processing displayed in the display section 28.

Reference number 303 denotes the name of an image effect not processed displayed in the display section 28.

Reference number 304 denotes an image effect bracket termination command for an image effect displayed in the display section 28. When the termination command 304 is selected and is executed by the operation section 70, unprocessed image processing is left unprocessed and the image effect bracket shooting is terminated.

In step S201, the image capturing section 22 performs image-capturing.

In step S202, the scene detection section 105 detects a shooting scene for the input image obtained in step S201.

In step S203, the image effect priority determination section 106 determines the priorities of image effects from the scene detected by the scene detection section 105, and further determines the types of image effects to be actually applied according to the priorities. How to determine the priorities from the shooting scene detected in step S202 will be hereinafter described in detail.

In step S204, the image processing section 24 performs, on the input image, image processing for applying the image effect determined to have the highest priority by the image effect priority determination section 106. Next, the image processing section 24 executes image processing for the image effects with the second highest to the N-th (N denotes a predetermined number) highest priorities.

In step S205, the images provided with the image effects by the image processing section 24 are sequentially displayed in the display section 28. At that time, the display section 28 is designed to clearly display not only the image to which an image effect has just been applied but also the applied image effects 301, the image effect being applied 302, and the image effect not applied 303, as shown in FIG. 3.

In step S206, it is determined whether processing has been completed for all of the image effects selected in step S203. The image effect bracket shooting ends if all of the image effect processing has been completed. The processing advances to step S207 if there is an unapplied image effect.

In step S207, it is determined whether or not the processing for the unapplied image effect is to be cancelled. The image effect bracket shooting ends if a user selects the image effect bracket termination command 304 at the operation section 70 by referring to the processing status of the image effects displayed in the display section 28 and does an operation of issuing an instruction to cancel the processing for the unapplied image effect. The processing advances to step S208 if subsequent processing is to be performed on the unapplied image effect.

In step S208, the size of the input image is reduced. The reduction processing may be reducing the number of pixels of each of the images to be subjected to the image effects with the subsequent priorities to the N-th highest priority to a predetermined number so that the sizes (the number of pixels) of the images are all equal, or gradually changing the sizes of the images according to the priorities.

In step S208, the image processing to be performed on the lower-priority images with the subsequent priorities to the N-th highest priority is made simpler than the image processing to be performed for the same purpose as that of the above processing on the higher-priority images with the priorities higher than the N-th highest priority. For example, the processing of creating the toy-camera feature for the images with the first to N-th highest priorities usually starts with reducing the amount of light in regions around an input image (lowering the brightness of pixels for a higher image height by increasing the gain) and ends with adding noises. In step S208, by contrast, only the light amount reduction is performed for simplification of processing. In the meanwhile, while diorama processing in step S204 includes several cycles of reduction, low-pass filtering, and enlargement for obtaining and synthesizing blurred images at several different blurring levels, the number of the cycles is set smaller (for example, one time) and only two images are synthesized in step S208. Further, when oil-painting and water-painting features are to be created for images, processing load and rate are increased more for simplified image processing on the subsequent images to the N-th image than for ordinary processing on the first to the N-th images in such a manner that the unit block for the simplified image processing is made larger than for the ordinary processing.

When the processing is finished, the processing advances to step S505 for displaying the processed images.

In step S209, the image processing section 24 performs the processing for the highest-priority image effect of the unapplied image effects on the input image with the reduced size. When the processing is finished, the processing advances to step S205 for displaying the image with the reduced size having been processed.

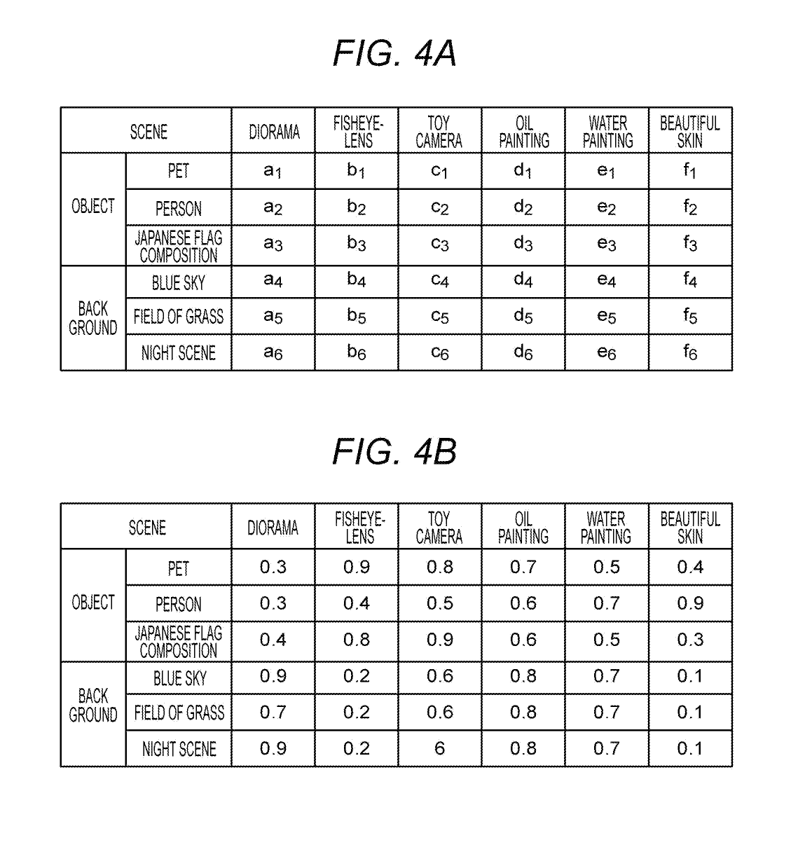

Subsequently, descriptions will be made, with reference to FIGS. 2 and 4, of a case where the image effect priority determination section 106 determines priorities from a shooting scene detected by the scene detection section 105 to allow an appropriate image effect to be selected when the present invention is implemented in accordance with the above processing flow.

FIG. 4A is a diagram illustrating the adaptation between a scene element detected by the scene detection section 105 and an image effect.

The adaptation takes the value from 0 to 1, both inclusive, and a larger adaptation indicates a higher compatibility between a shooting scene and an image effect. In the drawing, aₙ (n=1 to 6, both inclusive) represents the adaptations between the diorama image effect and the scene elements, bₙ (n=1 to 6, both inclusive) represents the adaptations between the fisheye-lens image effect and the scene elements, cₙ (n=1 to 6, both inclusive) represents the adaptations between the toy-camera image effect and the scene elements, dₙ (n=1 to 6, both inclusive) represents the adaptations between the oil-painting image effect and the scene elements, eₙ (n=1 to 6, both inclusive) represents the adaptations between the water-painting image effect and the scene elements, and fₙ (n=1 to 6, both inclusive) represents the adaptations between the beautiful skin effect and the scene elements. The adaptations between the scenes and the image effects (image processing methods) are shown in FIG. 4B.

Based on the adaptations, the priorities of the image effects are calculated for a scene detection result obtained by the scene detection section 105.

When the scene detection section 105 detects a scene with a pet, the Japanese flag composition, and a field of grass, the priority Sₐ of the diorama image effect is calculated as a₁+a₃+a₅ and the priority S_{b} of the fisheye-lens image effect is calculated as b₁+b₃+b₅. Likewise, the respective priorities S_{c}, S_{d}, Sₑ, and S_{f} of the toy camera, oil-painting, water-painting, and beautiful skin image effects are calculated as c₁+c₃+c₅, d₁+d₃+d₅, e₁+e₃+e₅, and f₁+f₃+f₅, respectively.

Next, the values of Sₐ, S_{b}, S_{c}, S_{d}, Sₑ, and S_{f} are compared and a higher value of them represents a higher image effect.

One of the image effects with the largest value is determined to have the highest priority and is applied in step S204.

Further, ones of the image effects with the priorities not higher than the second-highest priority and not lower than a threshold value are determined as the ones to be applied in step S208. The image effects with the priorities lower than the threshold value are determined to have low adaptations with the shooting scene for the image and are not applied.

The present invention thus enables generation of images subjected to various different image effects appropriate for a detected shooting scene.

Moreover, in the embodiment, some image effects suitable for a shooting scene are applied in priority to the other image effects. The processing for the other image effects is reducing an image or is simplified. This makes it possible to rapidly acquire images subjected to image effects with higher priorities and reduce the time required for the entire image processing while confirming the results of plural processing for image effects. Further, image effects which are suitable for a shooting scene and are to be actually applied are determined based on the priorities, and one of the image effects with the highest priority is applied to an input image while processing for the other image effects determined to be applied is simplified without compromising the original features of the effects. In that way, the entire time required for the image processing can be reduced.

While a preferred embodiment of the present invention has been described, the present invention is not particularly limited to the embodiment and various variations or alterations may be made within the scope of the gist of the invention. Further, although the example of the shooting scenes are a pet, a person, the Japanese flag composition, a blue sky, a field of grass, and a night scene in the embodiment and the examples of the image effects are the diorama image effect, fisheye-lens image effect, toy-camera image effect, oil-painting image effect, water-painting image effect, and beautiful skin image effect in the embodiment, the shooting scenes and image effects applicable to the present invention are not limited to those and other shooting scenes and image processing methods may be employed.

The present invention enables generation of images subjected to various different image effects appropriate for a detected shooting scene.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-089537, filed Apr. 23, 2014, which is hereby incorporated by reference herein in its entirety.

What is claimed is:

1. An image processor, comprising:
an image capturing unit;
an image processing unit configured to perform image processing on an image captured by the image capturing unit;
a detection unit configured to detect a shooting scene for the image captured by the image capturing unit;
a determination unit configured to determine priorities of a plurality of different image processing methods to be used by the image processing unit based on a result of the detection by the detection unit; and
a control unit configured to control the image processing unit so as to generate a plurality of images on which different image processing methods of the plurality of image processing methods have been performed in accordance with the priorities,
wherein the control unit simplifies image processing by using lower-priority image processing methods of the plurality of different image processing methods.

2. The image processor according to claim 1, wherein the lower-priority image processing methods are used for processing an image with a lower number of pixels than the pixels of an image processed by a higher-priority image processing method of the different image processing methods.

3. The image processor according to claim 1, wherein the lower-priority image processing methods perform a smaller number of synchronization processing steps than higher-priority image processing methods.

4. The image processor according to claim 1, wherein the lower-priority image processing methods have a larger unit block than higher-priority image processing methods for performing the same processing.

5. The image processor according to claim 1, further comprising:
a display unit configured to display an image processed by the image processing unit and a plurality image processing methods of the plurality of different image processing methods determined by the determination unit to be used for the image; and
an instruction unit configured to issue an instruction to stop image processing methods of the plurality of different image processing methods from being used for the images, wherein
the control unit accepts the instruction issued by the instruction unit to stop the image processing methods of the plurality of different image processing methods from being used when processing is to be sequentially performed on the image by the plurality of different image processing methods.

6. The image processor according to claim 1, wherein the control unit causes the display unit to clearly indicate image processing methods which have been used and image processing methods which have not been used and will be used when processing is to be sequentially performed on the image by the plurality of different image processing methods.

7. An image capturing apparatus, comprising:
an image capturing unit configured to take an image of an object and sequentially output image signals;
an image processing unit configured to perform image processing on an image captured by the image capturing unit;
a detection unit configured to detect a shooting scene for the image captured by the image capturing unit;
a determination unit configured to determine priorities of a plurality of different image processing methods to be used by the image processing unit based on a result of the detection by the detection unit; and
a control unit configured to control the image processing unit so as to generate a plurality of images on which different image processing methods of the plurality of image processing methods have been performed in accordance with the priorities,
wherein the control unit simplifies image processing by using lower-priority image processing methods of the plurality of different image processing methods.
a display unit configured to sequentially display images corresponding to the image signals.

8. A method for controlling an image processor, the image processor including an image capturing unit, an image processing unit configured to perform image processing on an image captured by the image capturing unit, and a detection unit configured to detect a shooting scene for the image captured by the image capturing unit,
the method comprising:
determining priorities of a plurality of different image processing methods to be used by the image processing unit based on a result of the detection by the detection unit; and
controlling the image processing unit so as to generate a plurality of images on which different image processing methods of the plurality of image processing methods have been performed in accordance with the priorities, and
controlling the image processing unit to simplify image processing by using lower-priority image processing methods of the plurality of different image processing methods.
